(19) United States
(12) Patent Application Publication
(10) Pub. No.: US 2003/0217770 A1
(43) Pub. Date: Nov. 27, 2003

(54) Combination thermal and pressure relief valve

(76) Inventors: Jeffrey A. Schultz, Pittsville, VA (US); Scott M. Scarborough, Altavista, VA (US)

Correspondence Address: BRINKS HOFER GILSON & LIONE, P.O. BOX 10395, CHICAGO, IL, 60611, US

(21) Appl. No.: 10/155,845

(22) Filed: May 24, 2002

(51) Int. Cl. F16K 17/14

(52) U.S. Cl. 137/73

(57) ABSTRACT

A combination thermal and pressure relief valve is disclosed that includes a first housing having an opening at a first end and a pathway extending towards the opening from a second end of the first housing. A second housing is partially received in the opening of the first housing, and the first and the second housings define a chamber adjacent the pathway. An exitway extends from the chamber to an exterior of the valve. A bearing element is within the chamber adjacent the pathway and is larger than a width of the pathway. A spring is within the chamber, is under compression, and in line with the bearing element. A thermal element is also within the chamber and in line with the spring. The thermal element melts at a predetermined temperature. The spring exerts a force on the bearing element such that the bearing element is biased against the pathway and forms a seal between the chamber and the pathway.

### BACKGROUND

The present invention relates to relief devices, and more specifically, to relief valves that provide pressure relief to a pressurized fluid within a container or canister when a predetermined temperature or pressure is exceeded.

Containers or vessels that contain a gas or liquid commodity under pressure may be equipped with relief valves to prevent a rupturing of the container due to excessive pressures or temperatures. Such relief valves will allow a resulting excess pressure to escape.

Several types of relief devices have been used to prevent excess pressure from building within a container. One device is a fitting that includes a fusible plug that blocks and seals an outlet passage in the container. Once the temperature surrounding the container reaches the yield point of the fusible plug, the plug melts and pressure forces the melted plug out through the passage, thus allowing the pressure in the container to escape. A problem may arise, however, in that the fusible plug may extrude over time when exposed to high pressures. This failure in turn may cause a pressure leak path. Therefore, this type of fusible plug may not be able to be used with containers containing commodities that normally are under higher pressures, thus limiting the types of commodities that may be used with the plug. Moreover, while the fusible plug may be effective when excessive thermal conditions are experienced, the fusible plug generally is not effective under excessive pressure conditions.

Another solution has been to use two relief devices: a pressure relief valve for when excessive pressures are experienced and a thermal fuse for when thermal relief is needed. In addition to the problems described above with respect to the fusible plug, this solution provides the disadvantage of requiring a container adapted for two relief devices.

Accordingly, it would be desirable to have a relief device that provides both pressure and thermal relief that overcomes the disadvantages and limitations described above.

### BRIEF SUMMARY

In order to address the need for an improved pressure relief device, a combination thermal and pressure relief valve is described below. According to one aspect of the combination thermal and pressure relief valve, a first housing is disclosed having an opening at a first end and a pathway extending towards the opening from a second end of the first housing. A second housing is partially received in the opening of the first housing, and the first and the second housings define a chamber adjacent the pathway. An exitway extends from the chamber to an exterior of the valve. A bearing element is within the chamber adjacent the pathway and is larger than a width of the pathway. A spring is within the chamber, is under compression, and in line with the bearing element. A thermal element is also within the chamber and in line with the spring. The thermal element melts at a predetermined temperature. The spring exerts a force on the bearing element such that the bearing element is biased against the pathway and forms a seal between the chamber and the pathway.

According to another aspect of the combination thermal and pressure relief valve, a thermal element is partially received in the opening of the first housing. The first housing and the thermal element define a chamber adjacent the pathway and the thermal element melts at a predetermined temperature. An exitway extends from the chamber to an exterior of the valve. A bearing element is within the chamber adjacent the pathway and is larger than a width of the pathway. A spring is within the chamber, is under compression, and in line with the bearing element. The spring exerts a force on the bearing element such that the bearing element is biased against the pathway and forms a seal between the chamber and the pathway.

According to another aspect of the combination thermal and pressure relief valve, a first housing has an opening at a first end and a pathway extending towards the opening from a second end of the first housing. A second housing is partially received in the opening of the first housing, and the first and the second housings define a chamber adjacent the pathway. An exitway extends from the chamber to an exterior of the valve. A bearing element is within the chamber and includes a sealing portion adjacent the pathway and a thermal element. The sealing portion is larger than a width of the pathway. The thermal element is adjacent the sealing portion and melts at a predetermined temperature. A spring is located within the chamber, is under compression, and in line with the bearing element. The spring exerts a force on the bearing element such that the bearing element is biased against the pathway and forms a seal between the chamber and the pathway.

According to another aspect of the invention, a pressurized container is disclosed. A container contains a fluid under pressure. A pressure and thermal relief valve is attached with and in fluid communication with the container. The pressure and thermal relief valve includes a first housing with an opening at a first end and a second housing partially received within the opening. A pathway extends towards the opening from a second end of the first housing. A chamber is adjacent the pathway and defined by the first and the second housings. An exitway extends from the chamber to an exterior of the valve. A sealing element is within the chamber and adjacent the pathway. The sealing element is larger than a width of the pathway. A spring is under compression within the chamber and in line with the sealing element. A thermal element is within the chamber and in line with the spring. The thermal element melts at a predetermined temperature. The spring exerts a force on the sealing element such that the sealing element is biased against the pathway and forms a seal between the chamber and the pathway.

The foregoing and other features and advantages will become further apparent from the following detailed description of the presently preferred embodiments, read in conjunction with the accompanying drawings.

### BRIEF DESCRIPTION OF SEVERAL VIEWS OF THE DRAWINGS

FIG. 1 is an embodiment of a combination thermal and pressure relief valve incorporated as an appurtenance to a pressurized container;

FIG. 2 is a side view of an embodiment of the combination thermal and pressure relief valve with a portion of the valve removed;

FIG. 3 is a second embodiment of the valve of FIG. 2; and

FIG. 4 is a third embodiment of the valve of FIG. 3.

### DETAILED DESCRIPTION OF THE PRESENTLY PREFERRED EMBODIMENTS

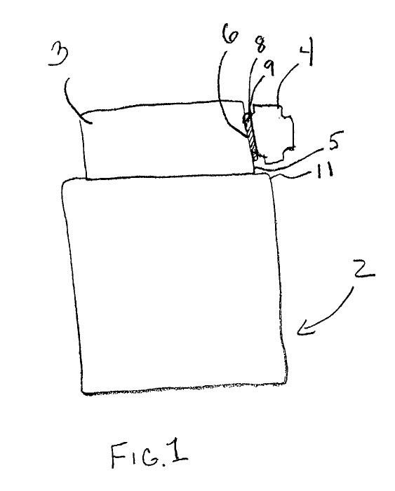

Turning now to the drawings, FIG. 1 illustrates one embodiment of a container 2 having a combination pressure relief valve and thermal pressure fuse 4 (herein after called “the valve”). The container preferably holds a liquid or gaseous fluid (not shown) under pressure. The pressure within the container 2 may build due to excessive temperature or pressure conditions. The valve 4, as will be more fully described below, provides pressure relief when a predetermined pressure or temperature is reached, thus preventing damage to the container or fluid.

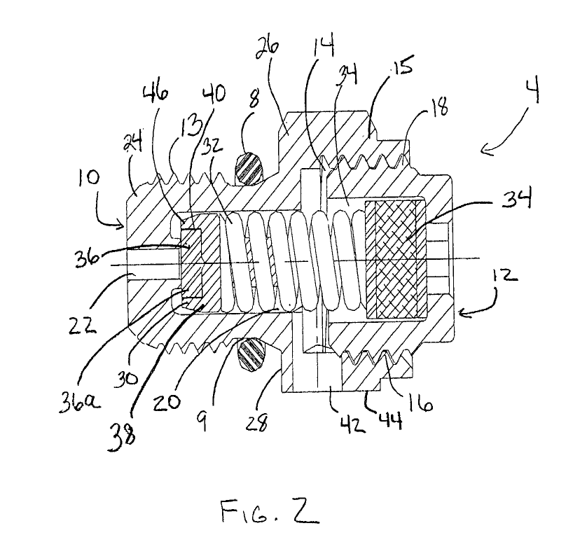

The valve 4 is incorporated into an opening 6 in a manifold 3 of the container 2, preferably by having exterior threads 13 (FIG. 2) on the valve 4 engage with interior threads (not shown) on the manifold 3. The manifold, in turn, is in fluid communication with the container such that the fluid may travel freely between the manifold and container. Preferably, the manifold 3 is attached to a top portion 11 of the container 2. Although not required, a seal 8 such as an O-ring may be located around an outer surface 9 of the valve 4 and adjacent an exterior wall 5 of the manifold 3. The seal 8 provides a sealing action between the manifold 3 and the valve 4.

Referring to FIG. 2, the valve 4 preferably includes a first housing 10 and a second housing 12. The first housing 10 includes a first end 15, a second end 24 opposite the first end, and a pathway 22 that extends from a second end 24 of the first housing 10 towards the first end 15. The pathway 22 is thus positioned so that it leads into and is in fluid communication with the manifold 3 (FIG. 1).

The second housing 12 is received in part within an opening 14 at the first end 15 of the first housing 10 (i.e., a portion less than the entire second housing 12 is received within the opening 14). In a preferred embodiment, the first housing 10 preferably includes interior threads 16 that engage with exterior threads 18 on the second housing, although in other embodiments the first and second housings may be otherwise attached, such as through the use of fasteners or the like.

The first housing 10 preferably is made of brass, although in other embodiments, the first housing may be made of steel, an aluminum alloy, or any other type of suitable alloy. In the present embodiment, the second housing 12 is also made of brass, but, as with the first housing, may also be made of steel, an aluminum alloy, or other alloy. Moreover, and as will be seen further below, the second housing may be also be made from a fusible material.

When the valve is incorporated as an appurtenance to a container such as the container 2 of FIG. 1, the second end 24 of the first housing 10 is within the opening 6 of the manifold 3 such that the pathway 22 leads into the interior of the manifold. The second housing and a remaining portion 26 of the first housing is outside of the container. Preferably, the portion 26 of the first housing outside of the container 2 includes a shoulder 28 that abuts the exterior wall 5 of the manifold.

The opening 14 of the first housing includes an exitway 42 that extends from the opening 14 through an outerwall 44 of the first housing such that the exitway 42 leads to the area outside of the valve 4. Preferably, the exitway is located along the portion 26 of the first housing between the shoulder 28 and the second housing 12.

The first and the second housings 10, 12 define a chamber 20. Preferably, the second housing 12 also has an opening 34 so that when the second housing 12 is received by the first housing 10, the openings 14, 34 of the first and second housings together define the chamber 20 adjacent the pathway 22. As shall be described further below, when the valve is in an actuated state, i.e., when the valve provides thermal or pressure relief, the chamber and the pathway are in fluid communication.

A bearing element 30, a spring 32, and a thermal element 34 are located within the chamber 20. The bearing element 30 is adjacent the pathway 22. As described in more detail below, at least a portion 36 of the bearing element 30 is made of a sealing material that is adjacent the pathway 22. In alternate embodiments, the bearing element 30 may be entirely made of a sealing material. The remainder of the bearing element 30 acts as a bearing surface that has a force exerted upon it by the spring 22.

Most preferably, and as shown in FIG. 2, the bearing element 30 includes a sealing member 36a adjacent the pathway and a pin 38 adjacent the sealing member 36. The sealing member 36a should be larger than the pathway 22. By way of example to illustrate the meaning of “larger”, if the sealing member 36a and the pathway 22 are both circularly shaped, the diameter of the sealing member should be greater than, and thus larger than, the diameter of the pathway.

A head 46 of the pin 38 acts a surface against which the spring 22 is biased when the valve 4 is in an unactuated state. Although not required, the head 46 of the pin 38 preferably has a receptacle 40 within which the sealing member 36a resides. In a preferred embodiment, the pin 38 is made of brass, although in other embodiments the pin may be made of other material such as those described for the first and the second housings.

Note that the bearing element 30 is shaped so that while it acts as a seal against the pathway 22, it does not act as a seal within the chamber 20. In embodiments that incorporate a pin 38, the head 46 of the pin 38 preferably is hexagonally shaped to allow gas or fluid to flow through the chamber. In other embodiments, of course, the bearing element may be otherwise shaped so long as it allows flow through the chamber.

The spring 32 is located adjacent the pin 38 and under normal conditions, when the valve 4 is in a non-actuated state, the spring 32 is under compression and bears against the pin 38 and the sealing member 36a. Thus, under normal conditions the spring 32 biases the pin 38 and the sealing member 36a against the pathway 22. The sealing member thus acts as a seal between the pathway 22 and the chamber 20.

Preferably, the spring 32 is a stainless steel spring, although the spring may also be made of silicon steel, a spring steel, or other suitable material that reduces the occurrence of failures such as fracture or creep failures. The spring material used may also depend on the type of fluid within the container, so that failures resulting from incompatibilities between the spring and the fluid, such as corrosion, may be reduced. Moreover, the load of the spring will be dependent on the thermal and pressure relief requirements associated with the fluid.

The thermal element 34 preferably is made from a eutectic material, and more preferably is a eutectic material made from a bismuth or tin alloy. In preferred embodiments, the thermal element 34 is placed at an end 40 of the chamber 20 opposite the bearing element 30 and adjacent the spring 32. In additional embodiments, by way of example, the thermal element may be placed between the spring and the bearing element. In embodiments that incorporate a sealing element and a pin, the thermal element may be placed between the pin and the sealing element. In general, the position of the thermal element 34 within the chamber 20 is unimportant so long as it is in-line with the spring 32 so that under normal conditions (i.e., when the valve is in an unactuated state) the spring will be biased against the thermal element.

Although the thermal element is normally made of a eutectic material, it may also be made of other materials having a low-melting point, the melting point being determined by the thermal relief requirements associated with the fluid. Examples include, but are not limited to, solders or low melting-point alloys.

Operation of the valve will now be described, with operation of the valve when thermal relief is needed being described first. As noted above, and in conjunction with FIG. 1, the valve 4 is incorporated into the opening 6 in the manifold 3, which is attached to the container 2 containing a gaseous or liquid fluid. Under normal conditions, the spring 32 is under compression and exerts a force against the bearing element 30 so as form a seal between the pathway 22 and the chamber 20. Thus, under normal conditions, the spring 32 biases the bearing element 30 against the pathway 22. The thermal element 34 is located in-line with the spring 32.

The thermal element 34 has a melting point that will cause it to melt, or lose its solid properties, when a predetermined temperature within the container 2 is reached. When this occurs, the thermal element melts, causing the spring 32 to decompress into the area previously occupied by the thermal element 34. When the spring 32 decompresses, the bearing element 30 is no longer biased against the pathway 22. Thus, the excess thermal pressure is able to enter from the pathway 22 and into the chamber 20, and exit through the exitway 42. The valve 4, therefore, provides for thermal relief and prevents damage to the container and/or fluid.

As noted above, the valve 4 also provides relief when a predetermined pressure is reached. The pressure within the container 2 enters the pathway 22 and applies a force against the bearing element 30. When the pressure in the container rises to the predetermined pressure, the pressure against the bearing element 30 exceeds the load of the spring 32. The spring 32 is thus further compressed and the bearing element 30 is no longer biased against the pathway 22. The excess pressure thus is able to enter into the chamber 20 and exit out the exitway 42.

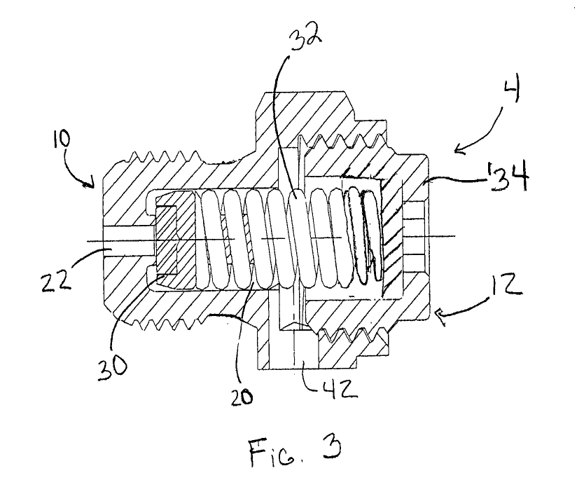

FIG. 3 illustrates an additional embodiment of the valve 4. The numbering of the elements of the drawing is the same as that of FIG. 2, except with differences noted with a prime (′) designation. In this embodiment, the second housing 12 performs the function of the thermal element ′34. The spring 32 is thus in-line, and typically adjacent to, the second housing 12. When the predetermined temperature is reached, the second housing 12 begins to melt. The spring 32 decompresses into the area previously occupied by the second housing. As described above for the previous embodiment, the bearing element 30 is no longer biased against the pathway 22. Thus, the excess thermal pressure may enter the chamber 20 and exit through the exitway 42. The operation of the valve 4 with respect to pressure relief is generally the same as that described above.

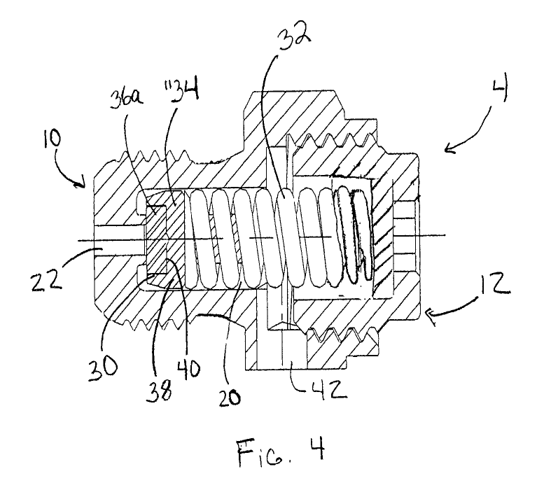

FIG. 4 illustrates another embodiment of the valve 4. The numbering of the elements of the drawing is the same as that of FIG. 2, except with differences denoted as double prime (″). In this embodiment, which incorporates a sealing element 36a and a pin 38, the pin 38 performs the function of the thermal element ″34. As noted above, the pin 38 may include a receptacle 40 to receive the sealing element 36a. To provide thermal relief, when the predetermined temperature is reached, the pin 38 will melt. The spring 32 decompresses, and the sealing element 36a thus is no longer biased against the pathway 22. The excess thermal pressure may enter the chamber 20 and exit through the exitway 42. The operation of the valve 4 with respect to pressure relief is generally the same as that described above.

Note that in a preferred embodiment, the thermal element is made of a material so that it melts in approximately 90 seconds when the temperature reaches a predetermined temperature of approximately 281 degrees Fahrenheit. In other embodiments, however, the thermal element may be of a material that melts in a greater or lesser amount of time, depending on specification requirements, and the predetermined temperature may be varied. Depending on specification requirements and the type of spring used, the valve may be actuated when the thermal element fully or partially melts.

The above described valve provides several advantages over other types of valves that provide thermal and pressure relief. For example, some other devices use a fusible plug that blocks and seals an outlet passage in a container. Once the temperature surrounding the container reaches the yield point of the plug, the plug melts and pressure forces the melted plug out through the passage, thus allowing the pressure in the container to escape. These fusible plugs, however, are subject to extrusion failures when exposed to high pressures. In contrast, the present valve incorporates a seal between the container and the thermal element. The thermal element, therefore, is not exposed to high pressures, and thus operates independently of pressure. The probability of an extrusion failure is therefore greatly reduced.

The present valve also requires only one device to provide thermal and pressure relief. Other systems may use both a pressure relief valve and a thermal fuse. Thus, in addition to overcoming the problems associated with fusible plugs, the present valve provides the advantage of requiring a container adapted for one relief device, rather than two.

By way of further example, in embodiments that incorporate a sealing element received within a pin, the parts are reusable with the exception of the thermal element. This in turn provides the advantage of requiring fewer replacement parts, thus lowering the costs associated with the valve.

While the above description constitutes the preferred embodiments of the present invention, it will be appreciated that the invention is susceptible of modification, variation, and change without departing from the proper scope and fair meaning of the accompanying claims.

1. A combination thermal and pressure relief valve, comprising:
a first housing having an opening at a first end and a pathway extending towards the opening from a second end of the first housing;
a second housing partially received in the opening of the first housing, the first and the second housings defining a chamber adjacent the pathway;
an exitway extending from the chamber to an exterior of the valve;
a bearing element within the chamber and adjacent the pathway, the bearing element being larger than a width of the pathway;
a spring within the chamber, the spring under compression and in line with the bearing element; and
a thermal element within the chamber and in line with the spring, the thermal element melting at a predetermined temperature;
wherein the spring exerts a force on the bearing element such that the bearing element is biased against the pathway and forms a seal between the chamber and the pathway.

2. The combination thermal and pressure relief valve of claim 1, wherein the second housing further includes an opening, and wherein the openings of the first and the second housings define the chamber.

3. The combination thermal and pressure relief valve of claim 1, wherein the exitway is adjacent the second housing.

4. The combination thermal and pressure relief valve of claim 1, wherein the bearing element includes at least in part a sealing element, the sealing element adjacent to the pathway.

5. The combination thermal and pressure relief valve of claim 4, wherein the bearing element further comprises a pin adjacent to the sealing element.

6. The combination thermal and pressure relief valve of claim 5, wherein the pin is adjacent the spring.

7. The combination thermal and pressure relief valve of claim 5, wherein the pin further includes a head having a receptacle that receives the sealing element.

8. The combination thermal and pressure relief valve of claim 5, wherein the pin is made of brass.

9. The combination thermal and pressure relief valve of claim 1, wherein the thermal element is made of a eutectic material.

10. The combination thermal and pressure relief valve of claim 1, wherein the thermal element is made of a low melting-point alloy.

11. The combination thermal and pressure relief valve of claim 1, wherein the first housing includes interior threads and the second housing includes exterior threads that engage with the interior threads of the first housing.

12. The combination thermal and pressure relief valve of claim 1, wherein the first housing and the second housing are made of brass.

13. The combination thermal and pressure relief valve of claim 1, wherein the spring is made of stainless steel.

14. The combination thermal and pressure relief valve of claim 1, wherein the thermal element is adjacent the spring.

15. The combination thermal and pressure relief valve of claim 14, wherein the thermal element is adjacent the spring at an end of the chamber opposite the bearing element.

16. The combination thermal and pressure relief valve of claim 14, wherein the thermal element is adjacent the bearing element and between the spring and the bearing element.

17. A combination thermal and pressure relief valve, comprising:
a first housing having an opening at a first end and a pathway extending towards the opening from a second end of the first housing;
a thermal element partially received in the opening of the first housing, the first housing and the thermal element defining a chamber adjacent the pathway, the thermal element melting at a predetermined temperature;
an exitway extending from the chamber to an exterior of the valve;
a bearing element within the chamber and adjacent the pathway, the bearing element being larger than a width of the pathway; and
a spring within the chamber, the spring under compression and in line with the bearing element;
wherein the spring exerts a force on the bearing element such that the bearing element is biased against the pathway and forms a seal between the chamber and the pathway.

18. The combination thermal and pressure relief valve of claim 17, wherein the thermal element further includes an opening, and wherein the openings of the first housing and the thermal element define the chamber.

19. The combination thermal and pressure relief valve of claim 17, wherein the exitway is adjacent the thermal element.

20. The combination thermal and pressure relief valve of claim 17, wherein the bearing element includes at least in part a sealing element, the sealing element adjacent to the pathway.

21. The combination thermal and pressure relief valve of claim 20, wherein the bearing element further comprises a pin adjacent to the sealing element.

22. The combination thermal and pressure relief valve of claim 21, wherein the pin is adjacent the spring.

23. The combination thermal and pressure relief valve of claim 21, wherein the pin further includes a head having a receptacle that receives the sealing element.

24. The combination thermal and pressure relief valve of claim 21, wherein the pin is made of brass.

25. The combination thermal and pressure relief valve of claim 17, wherein the thermal element is made of a eutectic material.

26. The combination thermal and pressure relief valve of claim 17, wherein the thermal element is made of a low melting-point alloy.

27. The combination thermal and pressure relief valve of claim 17, wherein the first housing is made of brass.

28. The combination thermal and pressure relief valve of claim 17, wherein the spring is made of stainless steel.

29. The combination thermal and pressure relief valve of claim 17, wherein the spring is adjacent the thermal element.

30. A combination thermal and pressure relief valve, comprising:
a first housing having an opening at a first end and a pathway extending towards the opening from a second end of the first housing;
a second housing partially received in the opening of the first housing, the first and the second housings defining a chamber adjacent the pathway;
an exitway extending from the chamber to an exterior of the valve;
a bearing element within the chamber, the bearing element including a sealing portion adjacent the pathway, the sealing portion being larger than a width of the pathway, and including a thermal element adjacent the seal, the thermal element melting at a predetermined temperature; and
a spring located within the chamber, the spring under compression and in line with the bearing element;
wherein the spring exerts a force on the bearing element such that the bearing element is biased against the pathway and forms a seal between the chamber and the pathway.

31. The combination thermal and pressure relief valve of claim 30, wherein the second housing further includes an opening, and wherein the openings of the first and the second housings define the chamber.

32. The combination thermal and pressure relief valve of claim 30, wherein the exitway is adjacent the second housing.

33. The combination thermal and pressure relief valve of claim 30, wherein the spring is adjacent the thermal element.

34. The combination thermal and pressure relief valve of claim 30, wherein the thermal further includes a receptacle that receives the sealing portion.

35. The combination thermal and pressure relief valve of claim 30, wherein the thermal element is made of a eutectic material.

36. The combination thermal and pressure relief valve of claim 30, wherein the thermal element is made of a low melting-point alloy.

37. The combination thermal and pressure relief valve of claim 30, wherein the first housing and the second housing are made of brass.

38. The combination thermal and pressure relief valve of claim 30, wherein the spring is made of stainless steel.

39. A pressurized container, comprising:
a container containing a fluid under pressure;
a pressure and thermal relief valve attached with and in fluid communication with the container, the pressure and thermal relief valve including:
a first housing with an opening at a first end;
a second housing partially received within the opening;
a pathway extending towards the opening from a second end of the first housing;
a chamber adjacent the pathway and defined by the first and the second housings;
an exitway extending from the chamber to an exterior of the valve;
a sealing element within the chamber and adjacent the pathway, the sealing element being larger than a width of the pathway;
a spring under compression within the chamber and in line with the sealing element; and
a thermal element within the chamber and in line with the spring, the thermal element melting at a predetermined temperature;
wherein the spring exerts a force on the sealing element such that the sealing element is biased against the pathway and forms a seal between the chamber and the pathway.

40. The pressurized container of claim 39, wherein the second housing further includes an opening, and wherein the openings of the first and the second housings define the chamber.

41. The pressurized container of claim 39, wherein the valve further comprises a shoulder that contacts an outer wall of the container.

42. The pressurized container of claim 41, wherein the exitway is between the second housing and the shoulder.

43. The pressurized container of claim 41, wherein the container further includes a manifold at a top of the container, and wherein the valve is attached with the manifold.

44. The pressurized container of claim 41, wherein the first housing includes exterior threads and the manifold includes interior threads that engage with the exterior threads of the first housing.

45. The pressurized container of claim 39, wherein the thermal element is adjacent the spring.

46. The pressurized container of claim 45, wherein the thermal element is adjacent the spring at an end of the chamber opposite the sealing element.

47. The pressurized container of claim 45, wherein the thermal element is adjacent the sealing element and the spring.

48. The pressurized container of claim 47, wherein the thermal element further includes a receptacle that receives the sealing element.

49. The pressurized container of claim 39, wherein the thermal element is made of a eutectic material.

50. The pressurized container of claim 39, wherein the thermal element is made of a low melting-point alloy.

51. The pressurized container of claim 39, wherein the first housing includes interior threads and the second housing includes exterior threads that engage with the interior threads of the first housing.

52. The combination thermal and pressure relief valve of claim 39, wherein the first housing and the second housing are made of brass.

53. The pressurized container of claim 39, wherein the spring is made of stainless steel.
